(19) United States
(12) Patent Application Publication
(10) Pub. No.: US 2018/0169703 A1
(43) Pub. Date: Jun. 21, 2018

(54) SAND SIFTER APPARATUS AND METHOD

(71) Applicant: David Clahassey, Wyoming, MI (US)

(72) Inventor: David Clahassey, Wyoming, MI (US)

(21) Appl. No.: 15/847,376

(22) Filed: Dec. 19, 2017

Related U.S. Application Data
(60) Provisional application No. 62/436,311, filed on Dec. 19, 2016.

(51) Int. Cl. B07B 1/02

(52) U.S. Cl. CPC B07B 1/02

(57) ABSTRACT

A sand sifter apparatus includes a sifting head comprising that has a screen extending rearward from a leading edge of the screen and upward from an intermediate portion of the screen. The sifting head also includes a runner that is disposed below at least a portion of the screen and has a front section that is coupled with a front portion of the screen. A handle is coupled with a forward portion of the sifting head, where the handle is configured for a user to pull the sifting head forward over a bed of sand to draw sand over and through at least a portion of the screen that is elevated by the runner away from the bed of sand.

### CROSS-REFERENCE TO RELATED APPLICATION

This application claims benefit and priority under 35 U.S.C. § 119(e) of U.S. provisional application Ser. No. 62/436,311, filed Dec. 19, 2016, which is hereby incorporated herein by reference in its entirety.

### FIELD OF THE INVENTION

The present invention generally relates to an apparatus that is used to manually remove debris from dry sand or sand that is under water, such as at a beach or sand play area or sport court.

### BACKGROUND OF THE INVENTION

Currently, there are various forms of sand cleaners and filters that may be used to clean beaches, such as manual and pull-behind rakes or the like. These known cleaners or filters typically face significant resistance from the sand in the sifting or filtering portion, frequently due to the tendency of the devices to move deeper into the sand surface. Further, such devices commonly require cumbersome secondary steps and processes of removing and disposing of accumulated debris.

### SUMMARY OF THE PRESENT INVENTION

The present invention provides an apparatus and system for sifting sand, such as beach sand, volley court sand, bunker sand, play area sand, or like areas that have sand capable of having or collecting unwanted objects, such as rocks or debris. The sand sifter apparatus is pulled over a bed of sand, above or below water, to remove such debris from the sand. The sand sifter apparatus includes a sifting head that has a screen with openings that are configured to filter debris from the bed of sand as the sifting head is pulled or drawn through an upper layer of the sand. The screen may have a front portion configured to filter sand entering over an upper surface of the screen and a rear portion angled upward relative to the front portion for capturing or retaining debris that is filtered from the sand. The sifting head may also include a runner disposed below at least a portion of the screen that is configured to elevate a portion of the screen above the bed of sand to permit the sand drawn over the screen to filter downward through the screen. A handle or tow member may be pivotally attached to the sifting head and is configured to pull the sifting head forward over and through the upper layer of the bed of sand.

According to one aspect of the present invention, a sand sifter apparatus is configured to be pulled over a bed of sand to remove debris from the sand. The sand sifter apparatus includes a sifting head that has a screen with openings that are configured to filter debris from the bed of sand and a runner disposed below at least a portion of the screen. A handle is pivotally attached to a forward portion the sifting head and has a distal end that is configured for a user to grasp and pull the sifting head forward over the bed of sand. The screen has a front portion configured to filter sand entering over an upper surface of the screen and a rear portion angled upward relative to the front portion for capturing debris that is filtered from the sand. The runner is configured to elevate the rear portion of the screen above the bed of sand to permit the sand to filter downward through the screen.

According to another aspect of the present invention, a sand sifter apparatus includes a sifting head comprising that has a screen extending rearwardly from a leading edge of the screen and upwardly from an intermediate portion of the screen. The sifting head also includes a runner that is disposed below at least a portion of the screen and has a front section that is coupled with a front portion of the screen. A handle is coupled with a forward portion of the sifting head, where the handle is configured for a user to pull the sifting head forward over a bed of sand to draw sand over and through at least a portion of the screen that is elevated by the runner away from the bed of sand.

According to yet another aspect of the present invention, a sand sifter apparatus is configured to be pulled over a bed of sand to remove debris from the sand. The sand sifter apparatus includes a sifting head and a handle pivotally attached to a forward portion the sifting head. The sifting head includes a screen with openings configured to filter debris from the bed of sand. The sifting head also includes a left side panel and a right side panel that are coupled at opposing sides of the screen to form an upward facing cavity that accumulates the filtered debris. The sifting head further includes a runner that is disposed below at least a portion of the screen and is configured to elevate the rear portion of the screen above the bed of sand. The handle has a distal end that is configured for a user to grasp and pull the sifting head forward over the bed of sand. Upon moving the handle rearward, the sifting head is configured to rotate rearward to dump the captured debris from the screen.

Accordingly to another aspect of the present invention, a method for removing debris from a bed of sand includes providing a sifting head that includes a screen with openings. The sifting head is moved forward through the bed of sand with a user pulling a handle that is pivotally attached to a forward portion the sifting head. A rear portion of a screen of the sifting head is elevated away from the bed of sand with a runner that is disposed below at least a portion of the screen. A leading edge of a front portion of the screen that is angled downward enters an upper layer of the bed of sand, where sand that enters over an upper surface of the screen is filtered downward through the screen for the filtered debris to be captured at a rear portion of the screen that is angled upward relative to the front portion of screen. The handle may optionally be moved rearward to causes the sifting head to tip over rearward to dump the captured debris from the screen.

These and other objects, advantages, purposes, and features of the present invention will become apparent upon review of the following specification in conjunction with the drawings.

### BRIEF DESCRIPTION OF THE DRAWINGS

FIG. 1 is an upper perspective view of a sand sifter apparatus with a handle used to move the sifter head through a bed of sand, in accordance an embodiment of the present invention;

FIG. 1A is a rear upper perspective view of the sand sifter apparatus shown in FIG. 1;

FIG. 2 is a front upper perspective view of the sand sifter apparatus shown in FIG. 1;

FIG. 3 is a rear elevational view of the sand sifter apparatus shown in FIG. 1;

FIG. 4 is a front elevational view of the sand sifter apparatus shown in FIG. 1;

FIG. 5 is a top plan view of the sand sifter apparatus shown in FIG. 1;

FIG. 6 is a side elevational view of the sand sifter apparatus shown in FIG. 1;

FIG. 7 is a side elevational view of the sand sifter apparatus shown with a height of the runner adjusted between an upper position and a lower position;

FIG. 8A is a side elevational view of the sand sifter apparatus shown with the runner adjusted to the upper position;

FIG. 8B is a side elevational view of the sand sifter apparatus shown with the runner adjusted to the lower position;

FIG. 9 is a side elevational view of the sand sifter apparatus shown being pulled through the sand and filtering debris at an upper surface of the screen; and

FIG. 10 is a side elevational view of the sand sifter apparatus rolled or rotated rearward to dump the captured debris from the screen.

### DETAILED DESCRIPTION OF EMBODIMENTS

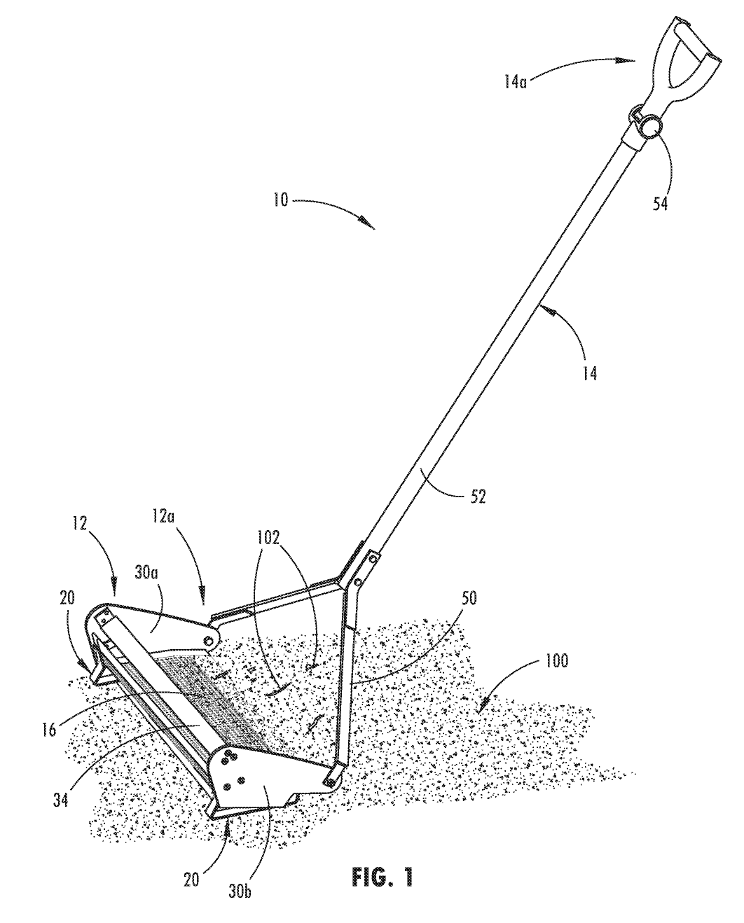

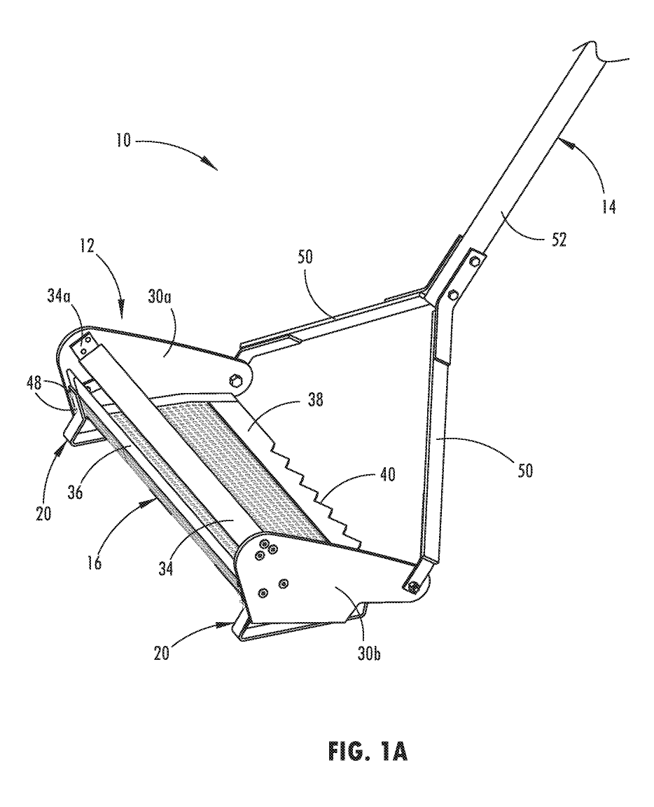

Referring now to the drawings and the illustrative embodiment depicted therein, a sand sifter apparatus 10 (FIG. 1) is configured to be moved, such as by being manually pulled, over a bed of sand 100 to remove debris 102 from the sand 100, such as for sifting beach sand, volley court sand, bunker sand, play area sand, or like areas that have sand capable of having or collecting unwanted debris, such as natural debris, like stick, leaves, and rocks, and unnatural debris, like plastic, paper, broken glass, and the like. The sand sifter apparatus 10 includes a sifting head 12 and a handle 14 attached to a forward portion 12a the sifting head 12. The sifting head 12 may have a screen 16 with openings 18 that are configured to filter the debris 102 from the bed of sand 100. The sifting head 12 may further include a runner 20 that is disposed below at least a portion of the screen 16 and is configured to elevate at least a rear portion 22 of the screen 16 above the bed of sand 100.

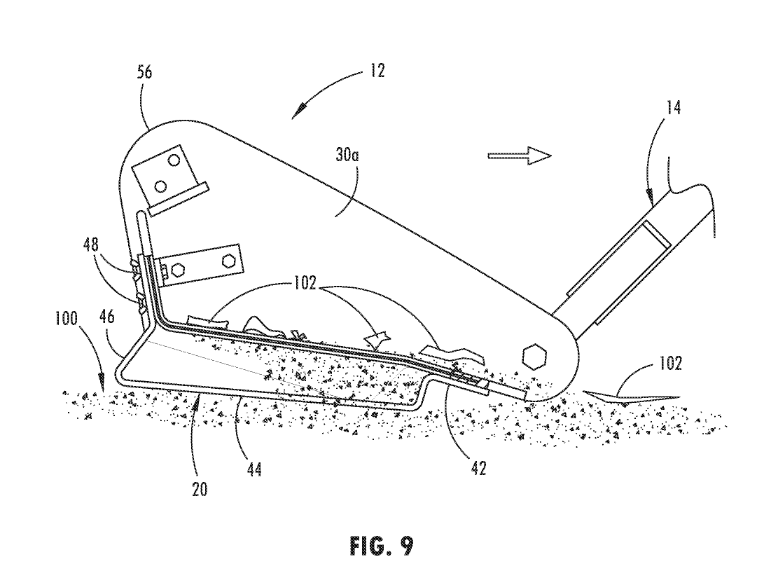

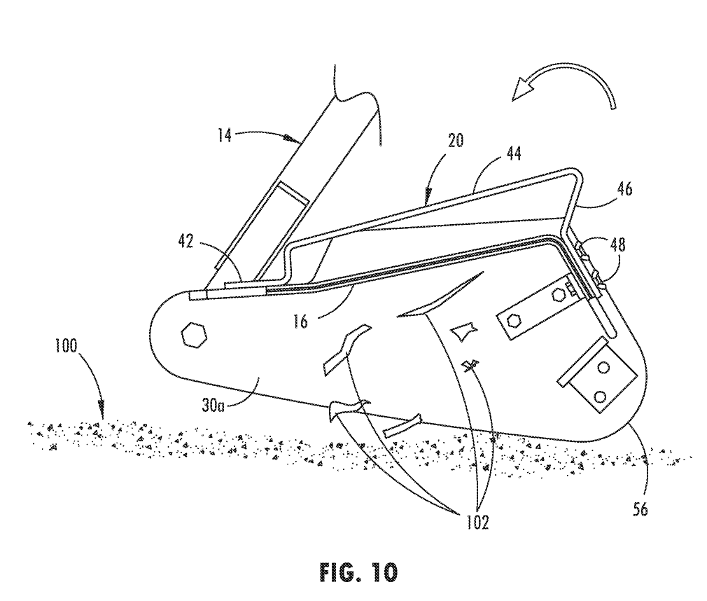

Accordingly, as shown in FIG. 9, when the filter head 12 is moved forward over the sand 100, such as by a user grasping and pulling a distal end portion 14a of the handle 14 an upper layer of the sand 100 is drawn onto an upper surface of the screen 16 so that the sand filters downward at the elevated portion of the screen 16 and the filtered debris 102 is collected at the upper surface of the screen 16. Once the screen 16 has accumulated debris 102 from the sand 100, the handle 14 may be moved rearward to cause the sifting head 12 to rotate rearward and dump the captured debris 102 from the screen 16, such as shown in FIG. 10.

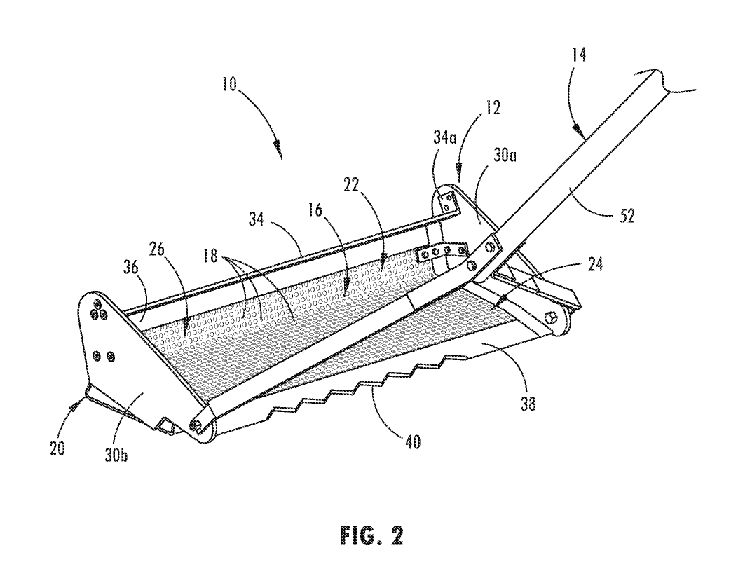

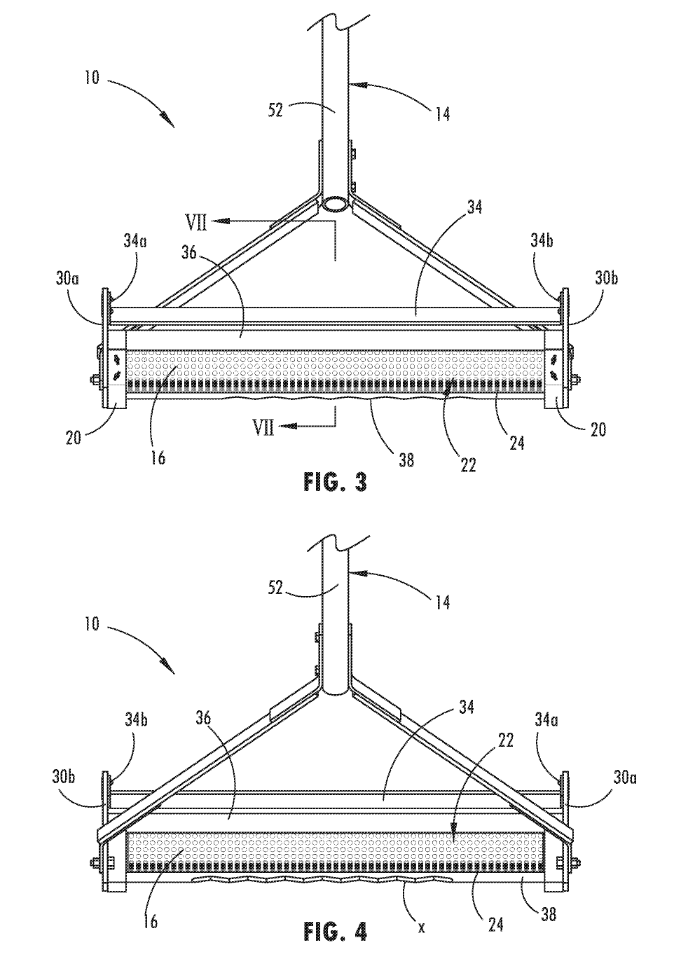

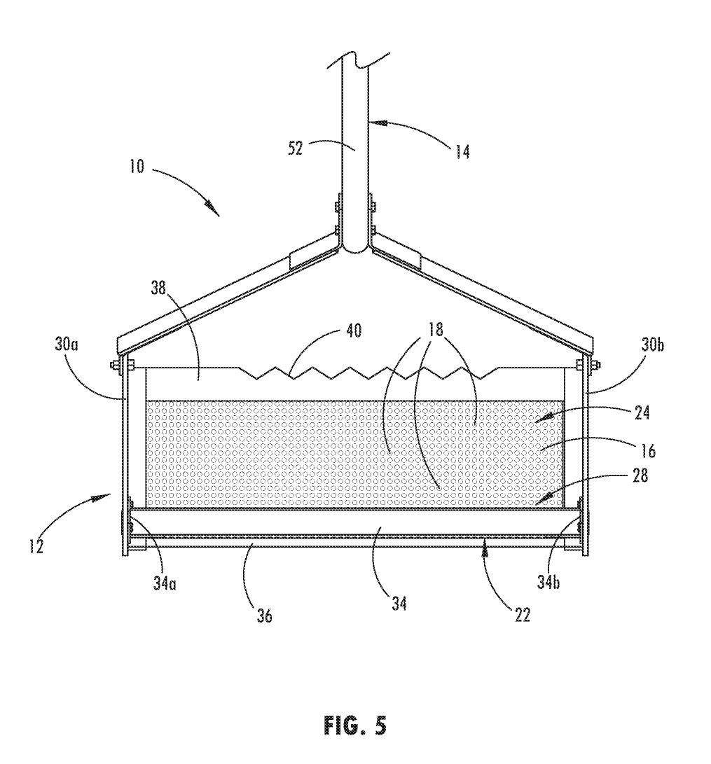

Referring to FIGS. 1-5, the sifting head 12 of the sand sifter 10 may have a screen 16 that filters debris 102 from sand that is drawn onto the upper surface of the screen 16 while the screen is moving forward over the bed of sand 100. As such, the screen 16 may include a sheet of material, such as a relatively rigid metal or plastic sheet material, which has holes or openings 18 (FIG. 2) that are sized to allow the sand to move through the openings 18, while generally retaining or preventing the debris 102 from moving through the openings 18. The screen 16 may be thus includes a woven mesh construction, net construction, perforated or punched plate construction, or a similar sieve or screen construction. Accordingly, the openings may have various shapes and sizes for the particular screen construction, sand type, and the desired particle filtering. In other embodiments, the screen may be conceivably be a similar flexible or pliable material or a combination of the above materials and/or construction types.

The screen 16, as shown in FIG. 2, may have a front portion 24 that is configured to filter sand 100 entering over an upper surface of the screen 16. The rear portion 22 of the screen 16 may be angled upward relative to the front portion 24 for capturing or retaining debris 102 that is filtered from the sand 100. As such, the front portion 24 of the screen 16 may be configured to filter sand 100 being drawn over the upper surface of the screen 16, where the rear portion 22 is angled upward relative to the front portion, such as at an angle 26 that is generally less than 150 degrees extending laterally across an intermediate portion 28 of the screen 16 (FIG. 7). Such an angled transition positions the rear portion 24 of the screen 16 generally upright for capturing and retaining debris 102 that is filtered from the sand 100. The angled transition between the front and rear portions 24, 22 of the screen 16 may have a curved shape and may be a tighter or a more gradual and larger curved transition that the illustrated embodiment. For example, the angle between front and rear portions 24, 22 may be between about 90 degrees and 100 degrees in one additional embodiment and may be between about 100 degrees and 110 degrees in another additional embodiment.

The sifting head 12 may also include lateral barriers that prevent the sand and debris from laterally moving off of the screen 16. As shown in FIGS. 1A and 2, a left side panel 30a and a right side panel 30a are coupled at opposing sides of the screen 16 to form an upward facing cavity that accumulates the filtered debris 102 (FIG. 9). Specifically, the left and right side panels 30a, 30b are attached along the front and rear portions 24, 22 of the screen 16, such as to be flush against the panels, to form such an upward facing cavity at the upper surface of the screen 16. As shown in FIG. 2-5, the left and right side panels 30a, 30b may be oriented substantially horizontally and may be substantially perpendicular to the screen 16.

The screen 16 may be attached to the side panels 30a, 30b in various ways, including welding, fasteners, adhesive, mechanical attachment, or other conceivable forms of attachments or combinations thereof. The side panels 30a, 30b may also or alternatively have a bottom edge portion 32 that extends inward and is used to attach to support and attach the screen 16. It is also contemplated that in additional embodiment the screen or portion thereof may be an integral piece of the bottom edge portion of the side panels.

The sifting head 12 may be further reinforced with structural cross members that extend laterally between the side panels 30a, 30b to support the screen 16 and maintain the vertical orientation of the side panels 30a, 30b. An upper cross member 34, such as shown in FIGS. 1-3, may secure to both side panels 30a, 30b and may be disposed between each side panel 30a, 30b. As shown in FIG. 2, the ends 34a, 34b of the upper cross member 34 have flanges that are attached with fasteners to the side panels 30a, 30b. Also, an arm 36 may be secure to both side panels 30a, 30b and may be disposed between each side panel 30a, 30b. The rear portion 22 of the screen 16 may be connected to the arm 36, such that the rear portion 22 of the screen 16 may be bound by the arm 36 at its rearward edge. Similarly, the front portion 24 of the screen 16 may be bound by a front edge member 38 that may be angled downward from a planar section of the front portion 24 of the screen 16. Such a downward angle may be configured for the screen 16 to dive downward into the bed of sand 100 when being pulled forward.

As shown in FIG. 2, the front edge member 38 may have a serrated edge 40 at its front edge. The serrated edge 40 may be sharp and thus configured to cut small grass in the sand and also enables the user to sift sand underwater and cut seaweed or similar underwater growth. Further, the leading edge of the edge member 38 may include a thickness that is greater than the thickness of the screen 16 to be robust and have the strength to withstand forces of the sifter head moving through the sand 100. Also, or alternatively, the front portion of the screen may integrally include a leading edge that is angled downward and is configured to enter into the bed of sand 100. Further, it is understood that the leading edge may alternatively be serrated or straight or other shapes or configurations that allow the sifter head to penetrate the sand.

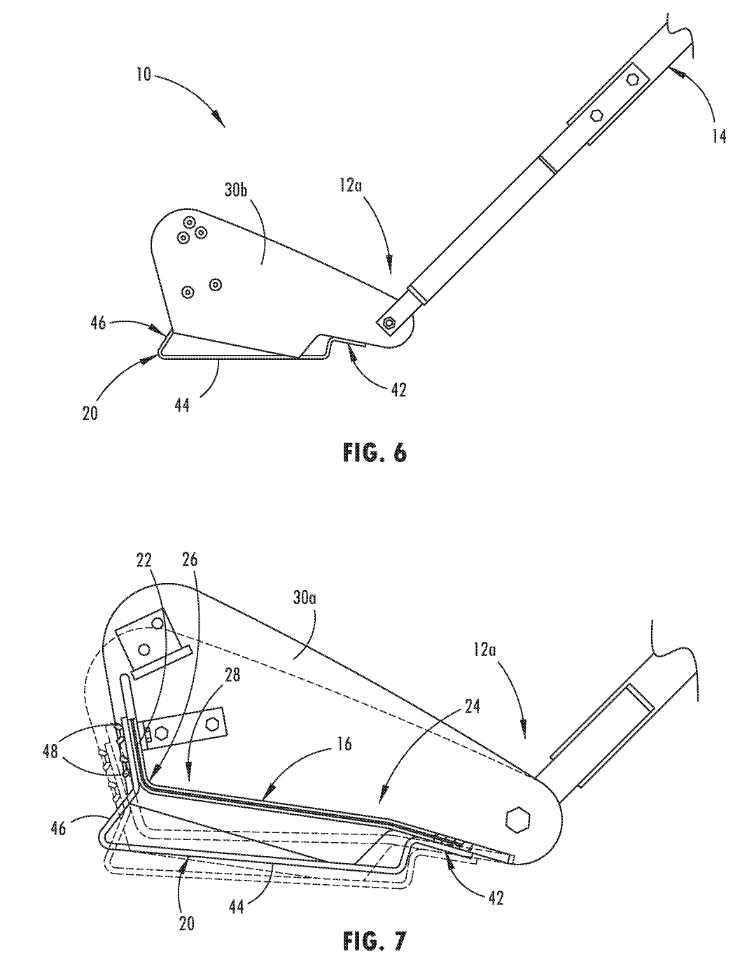

The sifting head 12 may also include a runner 20, such as shown in FIGS. 6-9, that is disposed below at least a portion of the screen 16 and has a front section 42 that is coupled at or near a front portion 24 of the screen. The runner 20 is configured to elevate at least a portion of the screen 16, such as the rear portion 22, above the bed of sand 100, as shown in FIG. 9, to permit the sand 100 to filter downward through the screen 16. As shown in FIG. 2, a runner 20 is disposed extending downward from each of the side panels 30a, 30b to raise the screen rear portion 22 off or above the ground when in use. The runner 20 may be about 2 inches wide and may be about 4 inches in length from front to back. In additional embodiments the runner may have a smaller or larger width, such as less than 3 inches in width, and may also have a longer or shorter length. Thus, the illustrated runners 20 are disposed at the left side and the right side of the sifting head 12 to elevate the rear portion 22 of the screen 16 away from the upper surface of the sand 100 generally continuously across the lateral extent of the screen 16.

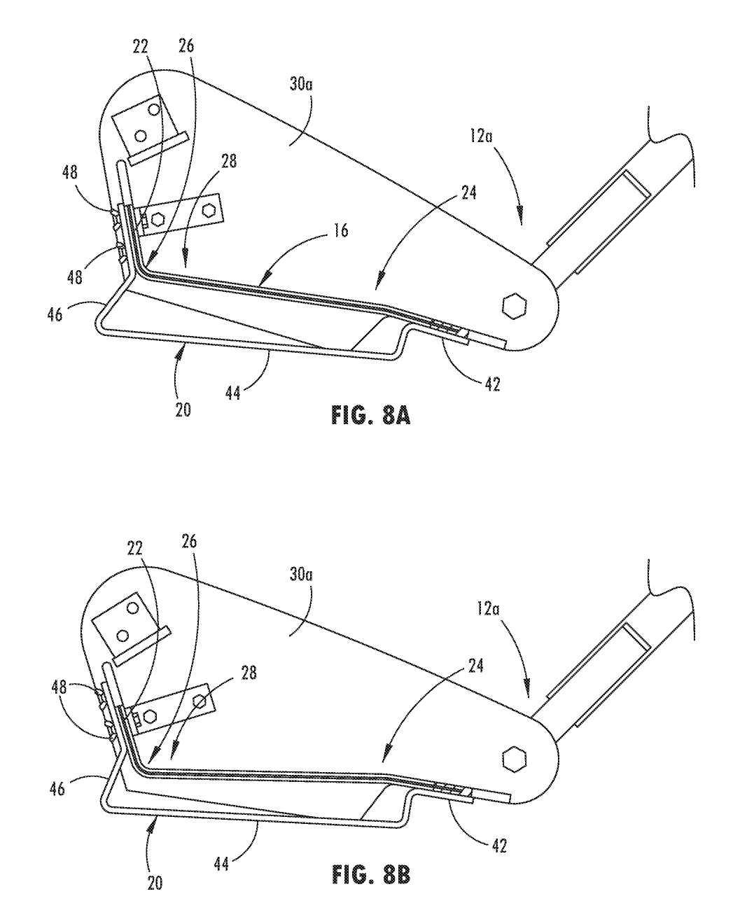

With further reference to the runners 20, they each include a bottom surface 44 (FIG. 9) that is configured to contact an upper surface of the sand 100, where the bottom surface 44 is spaced from a bottom surface of the screen 16. As shown in FIGS. 8A and 8B, the front portion 24 of the screen 16 has a planar section that is configured to be spaced from and generally aligned with the bottom surface 44 of the runner 20. Further, the runner 20 may be adjustable relative to the screen 16 for adjusting a distance or height that the rear portion 22 of the screen 16 is elevated from the upper surface of the sand 100 and/or for adjusting an angle of the screen 16 relative to the upper surface of the sand 100. Such height adjustment and pitch control may determine how deep the front edge of the screen 16 penetrates the sand.

To make such adjustment or adjustments, the runner 20 may include an elongated member that has a front section 42 that is coupled at or near a forward portion 12a of the sifting head 12 and a rear section 46 that is adjustably attached at or near a rearward portion of the sifting head 12. As such, the rear section 46 of the runner 20 may is adjustable between an upper position (FIG. 8A) and a lower position (FIG. 8B) that adjusts a pitch angle of a bottom surface 44 of the runner 20. As also shown in FIG. 7, the rear section 46 of the runner 20 may be adjustable by using a slotted notch and wing nut 48 where the runner 42 attaches at the base or bracket secured inside the side panels 30a, 30b. It is contemplated that in additional embodiments that the runner may include alternative shapes and may be alternatively attached to a component of the sifter head, such as to provide various alternative means of adjustment.

To attach the handle 14 to the sifter head 12, a brace 50 may be pivotally connected at a front portion of each side panel 30a, 30b so that the side panels may pivot with respect to the brace 50. The brace 50 may extend inwardly and forwardly to a pole or rod portion 52 of the handle 14. The handle 14 may be pivotally attached to the sifting head 12 at the connection between the brace 50 and the side panels 30a, 30b. Such pivotal attachment permits, upon moving the handle 14 rearward, the sifting head 12 to rotate rearward to dump captured debris 102 from the screen 16, such as shown in FIG. 10. Accordingly, the screen 16 may be able to pivot approximately 360 degrees, so long as the brace 50 does not impede its movement. However, such a brace may be configured to extend forwardly so each arm of the brace does not contact either of the side panels when the basket is rotated 360 degrees. To facilitate the rotational movement, the upper rear corners 56 of the side panels 30a, 30b, as shown in FIGS. 9 and 10, may be rounded and may act as a surface that rolls over the upper surface of the sand when pivoting the screen 16 and dumping the accumulated debris 102. This pivoting feature provides for the ease of emptying debris from the screen 16.

Also, as shown in FIG. 1, the handle 14 may include a gimbal or rotational coupling 54 that is disposed between the sifting head 12 and the distal end 14a of the handle 14. Such a gimbal or rotational coupling may allow the distal end 14a of the handle 14 to maintain a generally constant height upon rearward movement of the sifting head 12 over contours in the upper surface of the sand 100. The handle 14 may also or alternatively act as a tow member that is used to pull or tow the sifter head forward over and through the upper layer of a bed of sand. In use, the sand sifter 10 may be pulled by the handle 14, and the serrated edge 40 may be disposed under a top sand layer, to force sand and any debris in the sand into the basket 100. The runner 20 raises the rear of the basket so that sand may be dispersed through the screen 16 and out of the cavity or basket, so that only debris larger than the holes 18 of the screen 16 remain in the upper cavity or basket.

Although preferred embodiments of the invention have been discussed in detail for illustrative purposes, it will be recognized that variations or modifications of the disclosed apparatus, including the rearrangement of parts, lie within the scope of the present invention.

Also for purposes of this disclosure, the terms “upper,” “lower,” “right,” “left,” “rear,” “front,” “vertical,” “horizontal,” and derivatives thereof shall relate to the invention as oriented in FIG. 1. However, it is to be understood that the invention may assume various alternative orientations, except where expressly specified to the contrary. It is also to be understood that the specific devices and processes illustrated in the attached drawings, and described in this specification are simply exemplary embodiments of the inventive concepts defined in the appended claims. Hence, specific dimensions and other physical characteristics relating to the embodiments disclosed herein are not to be considered as limiting, unless the claims expressly state otherwise.

Changes and modifications in the specifically described embodiments may be carried out without departing from the principles of the present invention, which is intended to be limited only by the scope of the appended claims as interpreted according to the principles of patent law. The disclosure has been described in an illustrative manner, and it is to be understood that the terminology which has been used is intended to be in the nature of words of description rather than of limitation. Many modifications and variations of the present disclosure are possible in light of the above teachings, and the disclosure may be practiced otherwise than as specifically described.

1. A sand sifter apparatus configured to be pulled over a bed of sand to remove debris from the sand, said sand sifter apparatus comprising:
a sifting head that includes a screen with openings configured to filter debris from the bed of sand and a runner disposed below at least a portion of the screen;
a handle pivotally attached to a forward portion the sifting head and having a distal end configured for a user to grasp and pull the sifting head forward over the bed of sand;
wherein the screen has a front portion configured to filter sand entering over an upper surface of the screen and a rear portion angled upward relative to the front portion for capturing debris that is filtered from the sand; and
wherein the runner is configured to elevate the rear portion of the screen above the bed of sand to permit the sand to filter downward through the screen.

2. The sand sifter apparatus of claim 1, wherein the sifting head includes a left side panel and a right side panel that are coupled at opposing sides of the screen.

3. The sand sifter apparatus of claim 2, wherein the left and right side panels are attached along the front and rear portions of the screen to form an upward facing cavity at the upper surface of the screen.

4. The sand sifter apparatus of claim 1, wherein the handle is pivotally attached to a forward portion of at least one of the left side panel and the right side panel, and wherein upon moving the handle rearward, the sifting head is configured to rotate rearward to dump the captured debris from the screen.

5. The sand sifter apparatus of claim 1, wherein the front portion of the screen includes a leading edge that is angled downward and is configured to enter into the bed of sand.

6. The sand sifter apparatus of claim 1, wherein the runner includes a bottom surface that is configured to contact an upper surface of the sand, and wherein the front portion of the screen has a planar section that is configured to be spaced from and generally aligned with the bottom surface of the runner.

7. The sand sifter apparatus of claim 1, wherein the front portion of the screen is coupled with an edge member that is angled downward from a planar section of the screen and that is configured to enter into the bed of sand.

8. The sand sifter apparatus of claim 7, wherein a leading edge of the edge member includes a serrated shape and a thickness that is greater than the thickness of the screen.

9. The sand sifter apparatus of claim 1, wherein the runner is configured to be adjustable relative to the screen for adjusting a distance that the rear portion of the screen is elevated from the upper surface of the sand.

10. The sand sifter apparatus of claim 9, wherein the runner includes an elongated member having a front section that is coupled at or near a forward portion of the sifting head and a rear section that is adjustably attached at or near a rearward portion of the sifting head.

11. The sand sifter apparatus of claim 10, wherein the rear section of the runner is adjustable between an upper position and a lower position that adjusts a pitch angle of a bottom surface of the runner.

12. The sand sifter apparatus of claim 1, wherein the handle includes a rotational coupling disposed between the sifting head and the distal end of the handle.

13. The sand sifter apparatus of claim 12, wherein the rotational coupling comprises a gimbal that is configured to allow the distal end of the handle to maintain a generally constant height upon rearward movement of the sifting head over contours in the upper surface of the sand.

14. A sand sifter apparatus comprising:
a sifting head comprising (i) a screen extending rearwardly from a leading edge of the screen and upwardly from an intermediate portion of the screen and (ii) a runner disposed below at least a portion of the screen and having a front section coupled with a front portion of the screen; and
a handle coupled with a forward portion of the sifting head, wherein the handle is configured for a user to pull the sifting head forward over a bed of sand to draw sand over and through at least a portion of the screen that is elevated by the runner away from the bed of sand.

15. The sand sifter apparatus of claim 14, wherein a rear portion of the screen is connected to an arm that extends laterally between side panels that are coupled at lateral sides of the screen, and wherein the side panels and screen together form an upward facing cavity.

16. The sand sifter apparatus of claim 15, wherein the handle is pivotally attached to the sifting head, and wherein upon moving the handle rearward, the sifting head is configured to rotate rearward to dump captured debris from the screen.

17. The sand sifter apparatus of claim 14, wherein the runner is configured to be adjustable relative to the screen for adjusting at least one of (i) a height that a rear portion of the screen is elevated from the bed of sand and (ii) a pitch angle of a bottom surface of the runner.

18. The sand sifter apparatus of claim 14, wherein the front portion of the screen is coupled with an edge member that is angled downward from a planar section of the screen and that is configured to enter into the bed of sand.

19. A method for removing debris from a bed of sand, said method comprising:
providing a sifting head that includes a screen with openings;
moving the sifting head forward through the bed of sand with a user pulling a handle that is pivotally attached to a forward portion the sifting head;
elevating a rear portion of a screen of the sifting head away from the bed of sand with a runner disposed below at least a portion of the screen; and
entering an upper layer of the bed of sand with a leading edge of a front portion of the screen that is angled downward, wherein sand that enters over an upper surface of the screen is filtered downward through the screen for the filtered debris to be captured at a rear portion of the screen that is angled upward relative to the front portion of screen.

20. The method of claim 19, wherein moving the handle rearward causes the sifting head to tip over rearward to dump the captured debris from the screen.
